(19) United States
(12) Patent Application Publication
(10) Pub. No.: US 2010/0300325 A1
(43) Pub. Date: Dec. 2, 2010

(54) RAILROAD TUNNEL FAN CAR

(75) Inventor: Michael E. IDEN, Kildeer, IL (US)

Correspondence Address: PILLSBURY WINTHROP SHAW PITTMAN, LLP, P.O. BOX 10500, MCLEAN, VA, 22102, US

(73) Assignee: Union Pacific Railroad Company, Omaha, NE (US)

(21) Appl. No.: 12/473,671

(22) Filed: May 28, 2009

(51) Int. Cl. B61D 15/00; G01C 21/00; F04D 15/00; F04D 25/08; F04D 29/54

(52) U.S. Cl. 105/238.1; 701/213; 417/423.14; 417/411; 417/423.15

(57) ABSTRACT

Disclosed is a car body for use in a train which includes a fan mounted thereon and constructed to generate airflow at least in part in a longitudinal direction of the train. The car body may be coupled to one or more locomotives or car bodies within the train. As the train moves through a tunnel, for example, the fan is rotated by a power source to increase movement of air within the tunnel annulus, thereby reducing locomotive overheating or stalls within the tunnel. Flow directors to direct air into or out of the inlet and outlet of the fan may also be provided on the car body. Also, the fan may be mounted to the car body via a pivoting connection to allow for adjustment of its inlet/outlet and thus the generated airflow direction.

### BACKGROUND

1. Field of Invention

The present invention is generally related to reducing train stalls within tunnels by using a car with a fan to increase movement of air in the tunnel annulus.

2. Description of Related Art

Freight trains are often used to transport goods. As freight trains pass through railroad tunnels, overheating and loss of power of one or more locomotives within the train, and/or stalling of the train, may occur. This may often be caused by at least one of two factors: (1) the “piston effect,” and (2) accumulation of heated exhaust and pollutant gases. The “piston effect”—also referred to as the plunger effect—is a result of displacement flow which is the bulk movement of air or gases in a space, such as by the action of a piston or plunger in a cylinder-like shape. In the case of a train moving in a tunnel, for example, a leading locomotive (i.e., piston) tends to push air in the tunnel (i.e., cylinder) ahead of the train, thereby creating this effect. This results in lower air pressure in the tunnel and a reduction in air speed along the train. Additionally, as the train moves through the tunnel, the locomotive unit(s) expel exhaust gases and heated radiator cooling air into the air above and alongside the locomotive unit(s)—an area also referred to as the tunnel annulus. Because the piston effect reduces the flow of fresh air into the tunnel annulus, the exhaust gases and heated radiator cooling air tends to accumulate in the tunnel, particularly in tunnels of long length, and may move along with the locomotive unit(s) at the same relative speed. This is a particular problem for long freight trains incorporating multiple locomotives, as the locomotives, especially those further back in the train, will be forced to intake that heated/contaminated air.

The combined result of these factors is that the locomotive(s) may experience overheating due to resulting excessive radiator water and engine lubricating oil temperatures, for example, with the locomotives thus de-rating in power output or sometimes losing traction power. Also, lower air pressure in the tunnel, as caused by the piston effect, means less fresh air is available for intake and use in engine combustion. This may result in the train stalling in the tunnel. Such stalling incidents cause train delays, as well as risks to employees or personnel called to correct the problem.

To address such problems, several methods have been tried. Most railroad tunnels in the U.S. and Canada are non-ventilated; however, a small number of railroad tunnels are equipped with powered, stationary ventilation fan equipment mounted therein in the hopes of preventing such problems. Tunnel exit “curtains” have also been tried, such as illustrated in U.S. Pat. No. 4,037,526 to Jaekle, assigned to Southern Pacific Transportation Company, which illustrates an example of a ventilation method and apparatus for a train tunnel using a tunnel curtain to keep the air in front of the train from being pushed out of the tunnel (the piston effect). This encourages the air to be redirected backwards alongside the train. However, such curtains have proved to be maintenance-intensive and have been used sparingly.

A device and method that may be coupled within a train, at a desired location, to assist in preventing such effects and increase air movement around the locomotive(s) and train would be beneficial.

### SUMMARY

One aspect of the invention provides a car for use in a train, the car having a car body and track engaging wheels and including couplings for coupling the car within the train. A fan is also connected to the car body. The fan has an inlet for receiving air and an outlet for discharging air. The fan is constructed to generate airflow at least in part in a longitudinal direction of the train when the car body is coupled to the train.

Another aspect of the invention includes a train having at least one locomotive and a series of cars. The at least one locomotive has a body, track engaging wheels, and a power system for driving the track engaging wheels to move the locomotive and train along tracks. The series of cars each have a car body, track engaging wheels, and couplings for coupling the car within the train. One or more of the cars may be configured to transport cargo, and one or more of the cars has a fan connected to the car body. The fan has an inlet for receiving air and an outlet for discharging air. The fan is constructed to generate airflow at least in part in a longitudinal direction when the car body is coupled to the train.

In another aspect of the invention, a method of using a train to increase air movement is disclosed. The train has at least one locomotive having a body and track engaging wheels, and a series of cars each comprising a car body, track engaging wheels, and couplings for coupling the car within the train. One or more of the cars may be configured to transport cargo; and one or more of the cars includes a fan connected to the car body. The fan has an inlet for receiving air and an outlet for discharging air. The method includes: moving the train along a track, and generating airflow using the fan at least in part in a longitudinal direction of the train using the fan.

Other objects, features, and advantages of the present invention will become apparent from the following detailed description, the accompanying drawings, and the appended claims.

### BRIEF DESCRIPTION OF THE DRAWINGS

FIG. 1 illustrates a train comprising a car in accordance with an embodiment of the present invention;

FIG. 2 illustrates a side view of the car of FIG. 1 including a fan in accordance with an embodiment of the present invention;

FIG. 3 illustrates a top view of the car of FIG. 2 in accordance with an embodiment of the present invention;

FIG. 4 illustrates a top view of the car of FIG. 2 with the fan rotating about a pivoting connection in accordance with an embodiment of the present invention;

FIGS. 5a, 5b, and 5c illustrate a plurality of configurations for placement of the car of FIG. 1 within the train;

FIGS. 6a and 6b illustrate side views of an alternate fan car with a fan with a pivoting connection in accordance with embodiments of the present invention;

FIG. 7 illustrates an example of a mounting assembly for a fan on the car in accordance with an embodiment of the present invention;

FIG. 8 illustrates a detail of a locking pin for pivoting the fan in FIG. 7 in accordance with an embodiment of the present invention; and

FIGS. 9a, 9b, and 9c illustrate an example of the train of FIG. 1 using a communication device when travelling into, through, and out of (respectively) a tunnel along a track in accordance with an embodiment of the present invention;

FIGS. 10a, 10b, and 10c illustrate an example of the train of FIG. 1 using a communication device when travelling into, through, and out of (respectively) a tunnel along a track in accordance with another embodiment of the present invention; and

FIG. 11 illustrates an example of the train of FIG. 1 using a communication device for communicating with a locomotive when travelling through a tunnel along a track in accordance with an embodiment of the present invention.

### DETAILED DESCRIPTION OF THE PREFERRED EMBODIMENT(S)

It is generally known that the combined discharge of both engine exhaust and heat-carrying “cooling” air into the roofspace of the tunnel results in downward flow of exhaust, and thus contaminating air between the sides of the locomotive and the walls of the tunnel (i.e., tunnel annulus). As noted above, when trains move through tunnels, the locomotive(s) are subject to possible overheating and stalling (or near-stalling) due to the piston effect and combined exhaust gases in the air of the tunnel annulus.

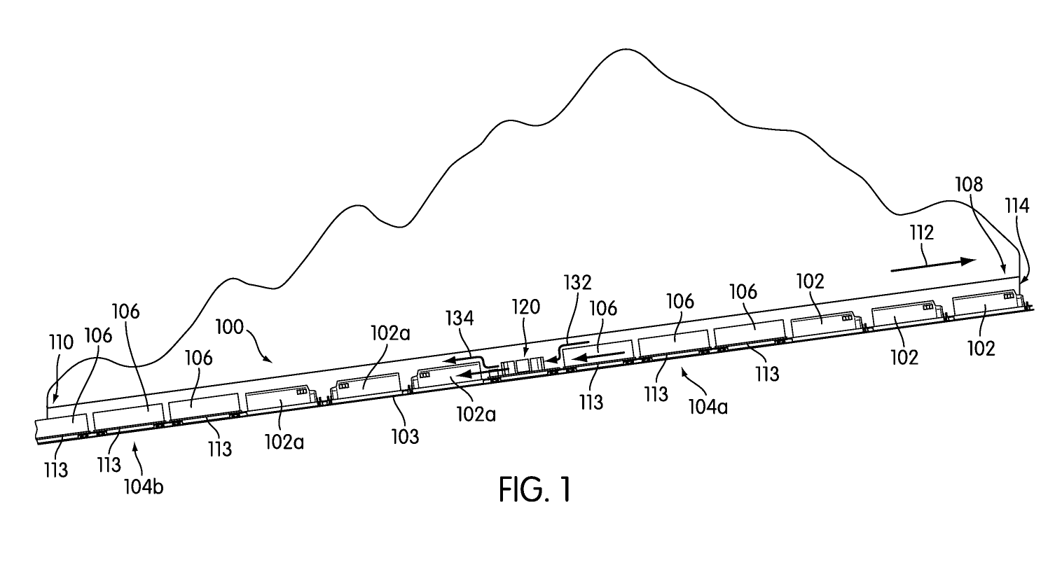

Thus, it is a goal of the present invention to increase the movement of air within the tunnel annulus as the train passes therethrough to decrease the temperature of air going into the diesel engine(s) and passing through the radiator(s), as well as reduce negative effects associated therewith. For purposes of this disclosure, “air” refers to the environmental air, exhaust gases, pollutants/contaminants, etc. that are contained within the tunnel, such as those within a center section of the length of the tunnel. For example, in the embodiment shown in FIG. 1, a freight train 100 is moving through a tunnel 114. The freight train 100 generally comprises at least one leading locomotive 102 at a front end 108 of the train for pulling a series 104 (or set) of freight cars 113 on railroad tracks or rails 103. A “car” may be generally referred to as a body with track engaging wheels 116 and couplings 136 that is connected in a train 100 for transporting items, and will become more evident by the description below.

In some cases, freight train 100 is used to transport goods, cargo, and other items that are of higher weight. Generally, throughout this description, the term “cargo” is used and defined as items for transport using the train 100. For example, cargo may comprise people, objects, liquids, and other transportable goods, and should not be limiting. One or more of the cars 113 may be configured to transport cargo. As such, to transport such cargo, in some embodiments the leading locomotive 102 may comprise a locomotive consist, as shown in FIG. 1, comprising a collection of two or more locomotives connected to each other in a series. Thus, for example, two or three locomotives may be provided at the front 108 of the train 100 to lead the train 100 along the tracks 103. Each locomotive 102 in the consist comprises a body and track engaging wheels for moving cars 113. The locomotive(s) 102 also comprise a power system for driving the track engaging wheels of the locomotive(s) 102 to move the locomotive(s) and the cars 113 along the tracks 103. The power system may be of any type, including but not limited to a diesel engine, an AC or DC generator powered by a diesel engine, a fuel cell, a battery, a flow battery, or any other system for providing locomotive power.

In some embodiments, a plurality of series 104 of cars 113 is provided. For example, a first series 104a and a second series 104b of wheeled cars may be provided in train 100. In some cases, therefore, to transport cargo, one or more additional locomotives or locomotive consists may be provided within the length of the train, such as represented by 102a, to assist in moving the series 104a and 104b. For example, an additional locomotive may be provided after a series 104a (or before series 104b, or between the two series) of cars 113. Alternatively, two or more locomotives 102a may form a second locomotive consist to assist in moving a second series 104b of cars. For example, in the embodiment of FIG. 1, a leading locomotive 102 or consist configured to lead the train 100 along the tracks 103 is provided, and a following locomotive 102a or consist is located rearward of the leading locomotive 102 which is configured to assist in moving the train 100 along the tracks 103. Generally a second or following locomotive or locomotive consist 102a may be provided in any number of positions along the length of the train 100. In some cases, the placement of one or more locomotives or locomotive consists 102 or 102a may be based upon the weight of the cargo or items being transported. The number of locomotives in the train 100, however, should not be limiting.

The freight cars 113 of each series 104a, 104b, etc. may be loaded or empty. The cars 113 may be any type of car and any combination of types of cars. For example, types of cars 113 in train 100 may include, but are not limited to, flat or gondola cars, box cars, tanks, hopper cars, and well cars. In some embodiments, one or more of the cars 113 may be configured to include a container 106 for storing cargo. For example, a car 113 may comprise a well car for receiving a container for transportation. Generally, containers 106 are used to store and transport goods, cargo, and other items, as is known in the art. The containers 106 may comprise containers that are removably or permanently mounted on a car body with wheels, and should not be limiting. For example, the containers 106 may be intermodal, sealed, refrigerated, temporary, etc. Though the Figures illustrate a plurality of containers 106 provided on the cars 113, it should be noted that it is envisioned that only some or none of the containers 106 may be included in the train 100. That is, train 100 may include cars 113 designed to carry many types of cargo, and should not be limited to the illustrated embodiment.

In any case, the freight train 100 may move through tunnel 114 in a direction 112, for example, at a desired speed for pulling the series 104a and 104b (or set) of cars 113 therethrough. As the freight train 100 moves therethrough, there is a possibility for overheating and/or stalling (or near-stalling) of one or more locomotives in consist 102 or 102a. For example, the air movement halfway through or in the midsection of the tunnel 114, such as near locomotive consist 102a in FIG. 1, is substantially low. Thus, the tunnel annulus contains a significant amount of contaminated and heated air. As such, a fan car 120 is provided and coupled within the train 100 to increase air movement. The term “fan car” as used herein refers to a device that is added or takes the place of a freight car 113 in a train 100 and which incorporates devices to redirect air or create airflow within a tunnel 114. Specifically, the fan car 120 is configured to assist or increase movement of air within the tunnel 114 and tunnel annulus as the train 100 passes through. In some cases, the air moves with the train relative to the tunnel walls.

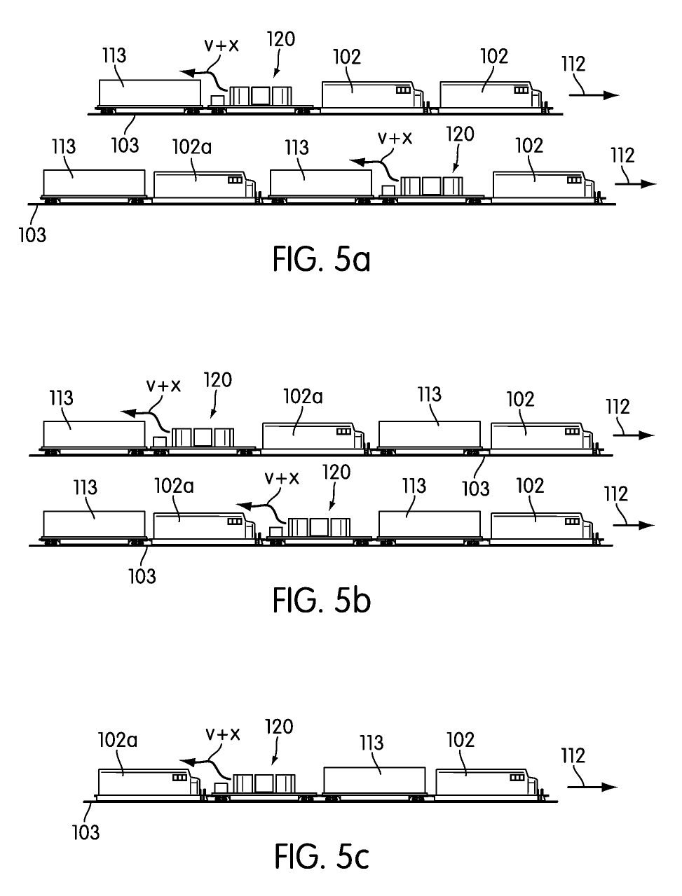

The fan car 120 may be mounted or coupled adjacent a locomotive or locomotive consist 102 or 102a in a desired location within the train 100. In the illustrated embodiment of FIG. 1, the fan car 120 is mounted forward and relative to locomotive consist 102a. The fan car 120 may be coupled via couplings 136 or links for coupling the car within the train, such as between the first set or series 104a and the second locomotive consist 102a, for example. In some embodiments, such as illustrated in FIGS. 5a-5c, the fan car 120 may be coupled or mounted behind and relative to locomotive or consist 102 or 102a. The fan car could also be coupled directly behind the leading locomotive consist 102 or directly in front of a mid-train locomotive consist 102a. The fan car 120 may be positioned or coupled at various locations in the train 100 including directly behind locomotive unit(s) 102 at the leading end or front of the train, such as shown in FIG. 5a. Also, the fan car 120 may be provided directly in front or, or directly behind, locomotive unit(s) 102a in a mid-train position, such as shown in FIG. 5b, or directly in front of locomotive unit(s) at an extreme rear end or trailing end of the train, such as shown in FIG. 5c. As such, the location of the fan car 120 within the train 100 should not be limiting.

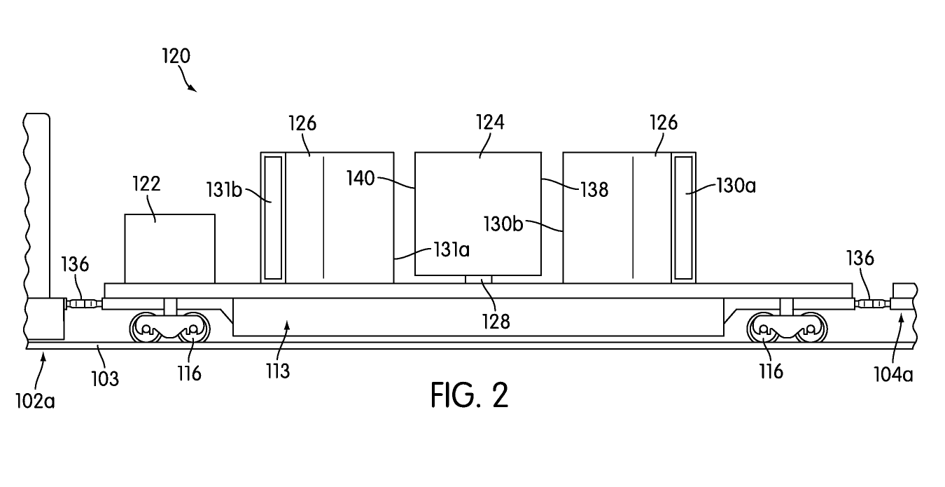

As shown in FIGS. 2-4, the fan car 120 comprises a car body 113 and track engaging wheels 116. An airflow generating device such as a fan 124 may be connected to or mounted to the car body 113. The term “fan” as used herein refers to any device for producing a current of air or generating airflow by the movement of a broad surface or a number of such surfaces (e.g., one or more blades). Generally, the fan 124 has an inlet 138 for receiving air and an outlet 140 for discharging air, as well as a plurality of blades (not shown) configured to rotate about an axis so as to move air from the inlet 138 to the outlet 140. In the illustrated embodiment, for example, one or more blades (not shown) may rotate about a substantially horizontal axis, thus generating airflow at least in part in a longitudinal direction of the train when the car body 113 is coupled to the train 100. Thus, when air is drawn through the inlet 138 as shown in FIG. 2, air may be directed in a rearward and longitudinal direction, relative to the train's direction of motion, as represented by 112, through outlet 140. The fan 124 may generate airflow via intake or suction through its inlet 138. The fan 124 may also generate airflow through its outlet 140.

In some cases, the fan 124 may comprise a vane axial, tube axial, or propeller-type fan, for example. However, the axial positioning of the blades should not be limiting. For example, it is envisioned that, in an embodiment, the fan 124 may also be a centrifugal fan (e.g., directing air toward the side walls of a tunnel 114). Also, the type, shape, pitch, or number of blades used in fan 124 should not be limiting.

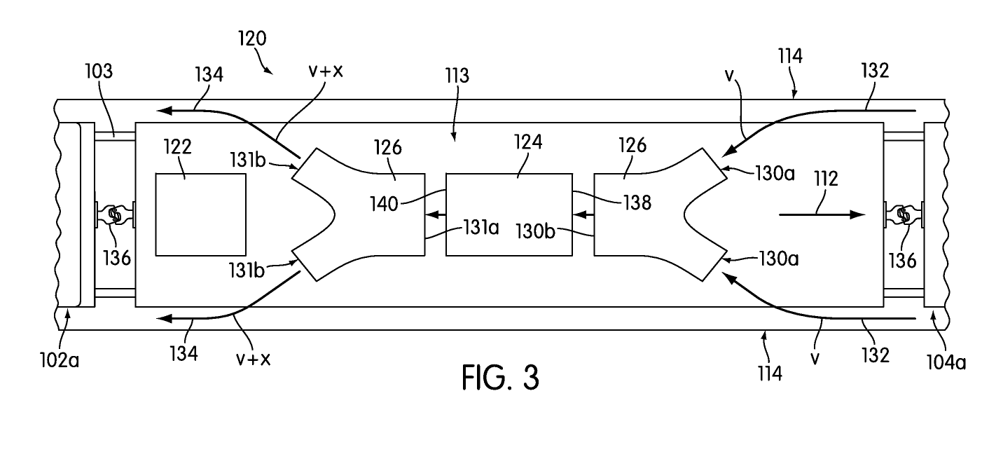

The fan 124 of fan car 120 imparts movement to the air within the tunnel annulus as the train travels through in a direction 112, for example. For example, should air flow into the fan 124 via inlet 138 at a velocity “v,” air will flow out of the fan at a velocity “v+x.” FIGS. 3 and 5 illustrate this concept. By increasing the volume and velocity of air that flows in the tunnel annulus (i.e., alongside the train while in the tunnel), the ventilation of the tunnel is improved. For example, when the high tonnage train 100 is ascending through a tunnel 114 at a slow speed, there is an increase or assistance in air movement around the mid-train locomotive units (i.e., locomotive consist 102a). Also, by imparting or increasing the kinetic energy of the air surrounding the train, such as in a rearward and longitudinal direction, at least some of the exhaust gases, hot air, soot, etc. generated by the locomotive engines and contaminants previously contained in the air are carried or moved as the train 100 moves through the tunnel 114. Such generation of air movement is also useful in reducing locomotive overheating and train delays or stalls in railroad tunnels, as the heated/contaminated air accumulation in the tunnel 114 decreases. Further, by providing air movement in a tunnel, the fan car 120 aids in cooling the locomotive(s) 102 and 102a (and their parts, including, but not limited to the engine parts, coolants, etc.), and prevents such effects as the piston effect.

Preferably, in an embodiment, the fan 124 is designed to generate airflow of at least 75,000 ft³/s (cfm). In some cases, the airflow may reach up to and including 125,000 cfm. Of course, the amount of generated airflow should not be limiting. For example, it is envisioned that the speed or rate of rotation of the fan 124 may be adjustable.

In some embodiments, the fan car 120 may also comprise one or more power sources 122 for imparting motion to the fan 124 (e.g., rotating one or more of blades of the fan 124 about its axis) to generate airflow. In some embodiments, the power source 122 may be an existing power source such as one that is provided in a locomotive, car, or container. In the illustrated embodiment, the power source 122 is a separate and distinct device that is mounted to a top of the car body 113. However, such a mounting location should not be limiting. In any case, the power source 122 may include a plurality of devices, such as, but not limited to, an engine (e.g., diesel engine), a motor (e.g., electrical motor), a battery, a generator, or a combination thereof, for example. In some embodiments, the power source 122 may be rechargeable. For example, in some cases, the power source 122 may include devices such as solar panels for charging a battery. The power source 122 may be remotely activated or a continuous power source. In any case, the power source 122 may be capable of imparting motion to the blades of the fan 124.

Though not described in detail, it is to be understood that the fan 124 may be connected to the power source 122 (or an existing power source) using devices such as gears, wheels, power trains, etc. In an embodiment, the rotation of the blades is caused by a gear train connecting the fan 124 to the wheels 116 of the car 120. For example, it is envisioned that the wheels 116 could translate the motion of the train 100 into mechanical rotation of the fan 124. As such, the devices and methods for configuring the fan 124 to generate airflow should not be limited.

The fan car 120 may also incorporate one or more flow director devices 126 such as air intakes, exhausts, nozzles, and/or ports for directing or redirecting the airflow generated by the fan 124, and increase movement thereof. For example, also shown in FIGS. 2-4 are flow directors 126 on fan car 120 to direct the flow of air into and/or out of the fan 124 via ports, and thereby increase the efficiency of the fan 124 for moving air, for example. A flow director 126 maybe used to assist in directing air into the fan 124 when airflow is generated through the inlet 138, and/or to assist in directing air from the fan 124 when airflow is generated out of the outlet 140.

Each flow director 126 may comprise a substantially “Y”-shaped body, for example. Thus, the body may comprise a pair of diverging ports and a single port, that are positioned adjacent the fan 124 as two inlets and one outlet, or two outlets and one inlet. In the illustrated embodiment, two Y-shaped flow directors 126 are positioned on the car body 113 on opposing longitudinal sides of the fan 124, such that they are aligned with the inlet 138 and outlet 140 of the fan 124, and in a manner that a single port is facing the fan 124 and a pair of diverging portions are facing away from the fan 124. Specifically, a first flow director is mounted such that its outlet 130b is aligned with and facing the inlet 138 of fan 124. A second flow director 126 is mounted such that its inlet 131a is aligned with the outlet 140 of fan 124, and its outlet 131b is facing away from the fan 124.

FIG. 3 illustrates how the flow directors 126 in such a configuration direct air with respect to the fan 124 when the train is moving in a direction represented by arrow 112. For example, as the train 100 moves, air may be directed or pulled as represented by arrows 132 into the inlets 130a of a first flow director 126. Air may be pulled from areas adjacent the fan 124, such as overhead and side locations, for example. Air is directed and/or pulled from these inlets 130a through an outlet 130b and into inlet 138 of the fan 124. The fan 124 pushes the air out of its outlet 140 and into or toward the inlet 131a of the second flow director 126. The air is then redirected through the outlets 131b in a direction as represented by arrows 134. For example, the air may be directed alongside or overhead the train 100.

The above described directional movement of the air in direction 134 via the “Y”-shaped flow directors 126 is advantageous as it directs air toward the fan 124 and then around the adjacent device (i.e., in this case, it is directed around the locomotive consist 102a, as shown in FIG. 1, for example). As such, the air is substantially directed away and/or prevented from contacting a face of the following locomotive 102a. This allows the energized air to move freely within the tunnel annulus around the train 100, while assisting in providing ventilation for the locomotive unit(s).

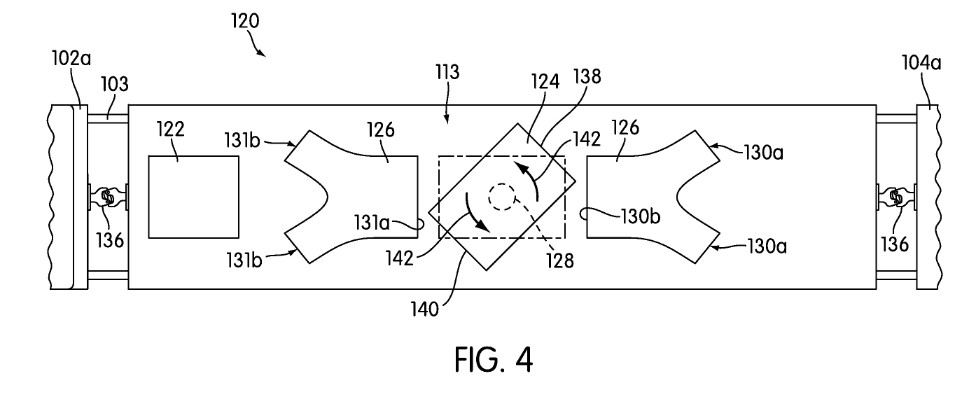

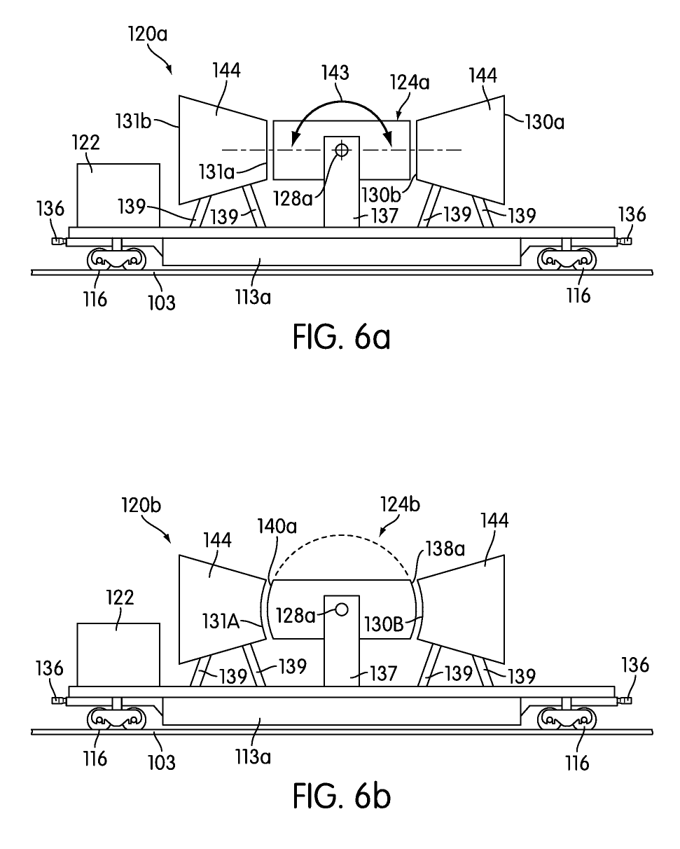

Though the shape of the illustrated flow directors 126 provides the above-noted advantages, the flow directors 126 need not be provided or limited to the Y-shape as illustrated in FIGS. 3 and 4 to provide such efficiency or features. For example, in some cases, flow directors may comprise a single inlet and a single outlet, or a plurality of inlets and a plurality of outlets. In an embodiment, flow director 126 may comprise a substantially curved shape, such as a “J”-shape or an “S”-shape. In an embodiment, flow director 126 may comprise two such shapes, such as two J-shaped devices, having two inlets and two outlets for directing/redirecting air therethrough and with respect to the fan 124. The air may be directed around and/or adjacent the train 100 or objects within the train in any number of directions (overhead, alongside, etc.). An alternative embodiment and design of the flow director is described below with reference to FIGS. 6a and 6b.

Also, flow directors 126 need not be provided for both the inlet 138 and the outlet 140 of the fan. Flow directors 126 may be provided only at the inlet 138 or only at the outlet 140, for example. In some cases, flow directors 126 may not be provided at all. Further, the mounting location of the flow directors 126 should not be limiting. For example, although the flow directors 126 are shown mounted to the car body 113, and in relation to the fan 124, it is envisioned that, in some embodiments, the flow directors 126 may be portable or removably attached devices that are connected to one or more parts of the fan 124, such as connected directly to the inlet 138 and/or outlet 140, for example. As such, the flow directors 126 may comprise substantially curved walls or shapes for directing air into and out of the fan 124.

Furthermore, the positioning and shape of the flow directors 126 should also not be limiting. For example, in the case of using a centrifugal fan as fan 124, i.e., a fan which directs gases or air approximately 90 degrees outward from its inlet, it is envisioned in some embodiments that flow directors 126 may be positioned on the car body 113 according the location of the inlet 138 or outlet 140 of the fan 124.

In some cases, the fan 124 may be mounted to the car body 113 via a pivoting connection 128, such as shown in the example embodiment of FIG. 4. A mounting structure including a pivoting connection 128 or the pivoting connection 128 itself may be used to mount the fan 124 to the car body 113. The pivoting connection 128 allows for adjustment of the fan 124 with respect to the car body between at least two positions, so that the direction of the generated airflow with respect to the train is adjustable. In the embodiment shown in FIG. 4, the pivoting connection 128 imparts rotation to fan 124 about a vertical axis with respect to the car body 113, so that the fan 124 (and its respective inlet 138 and outlet 140) may be adjusted to a position about the vertical axis. This connection of the fan 124 to the car body 113 allows for adjustment in either direction about the vertical axis, as represented by arrows 142. The pivoting connection 128 may allow the fan 124 to rotate about or pivot up to and including 360 degrees about the vertical axis.

In some cases, a locking mechanism (not shown) may be provided to lock the pivoting connection 128 at one or more specific locations about the axis. For example, a locking mechanism may be associated with the pivoting connection 128 itself, its mounting, or with the car body 113. The locking mechanism could position the inlet and the outlet of the fan 124 such that air is directed in an opposite direction or in a perpendicular direction (e.g., in the tunnel annulus, towards the side walls of the tunnel 114), for example. The locking mechanism may comprise a pin type locking mechanism, wherein one or more pins are inserted and locked in openings. The locking mechanism may also comprise a rotation limiting mechanism, so as to limit rotation of the pivot connection 128. One example of a locking mechanism is described with respect to FIG. 8. However, the type of locking mechanism used should not be limiting.

A rotating or pivoting connection 128 enables one to direct the intake and exhaust of the fan 124 with respect to the train 100, and thus may assist in directing/redirecting air, as noted above with respect to the flow directors 126, around the surrounding locomotives 102 or 102a or cars 113 (or containers 106, if provided). Additionally, the pivoting connection 128 allows personnel or an operator to adjust the position of the inlet and thus the direction for directing/redirecting air. For example, in some embodiments, if so desired, the fan 124 may be positioned (e.g., using a locking mechanism) such that it draws air through inlet 138 and through outlet 140 in an opposite direction to arrows 132 and 134. That is, the fan 124 may expel air through its outlet 140 in a same direction (e.g., forward) that the train is moving as represented by arrow 112.

FIGS. 6a and 6b illustrate side views of alternate fan cars 120a and 120b each comprising a fan 124a and 124b, respectively, connected to a car body 113a in accordance with other embodiments. In these example embodiments, each fan 124a and 124b is mounted via a mounting assembly 137 to an upper surface of the car body 113. The mounting assembly 137 for each fan includes a pivoting connection 128a which is configured to impart rotation to fan 124a about a horizontal axis that is perpendicular to a longitudinal axis of the car body 113 and train 100. The embodiments of FIGS. 6a and 6b allow for adjustment of the fans 124a and 126b (and their respective inlets 138 and outlet 140) to a position in either direction about the horizontal axis, as represented by arrow 143. The pivoting connection 128a may allow the fans 124a and 124b to rotate about or pivot up to and including 180 degrees about a horizontal axis. The fans 124a and/or 124b may also rotate up to and including 360 degrees about the horizontal axis. In some cases, a locking mechanism (not shown), as described above, may be provided to lock the pivoting connection 128a at one or more specific locations about the axis.

FIGS. 6a and 6b also illustrate flow director devices 144 of an alternative design which may be provided on the fan cars 120a and 120b as air intakes, exhausts, nozzles, and/or ports for directing or redirecting the airflow generated by the fans 124a, 124b. The flow director device 144 is connected to car 113 via a number of mounting braces or links 144 such that it may be aligned with the fan, for example. The flow director devices 144 acts in a similar manner to the flow director devices 126 described with respect to FIGS. 2-4, for example. The flow director device 144 may be positioned on one or either side of the fan 124 so as to provide an inlet 130a, outlet 130b and/or inlet 131a, outlet 131b with respect to fan 124a or 124b.

In an embodiment, the fan car 120 comprises a configuration that allows for a close-fit design between its fan and one or more flow directors. For example, FIG. 6b illustrates a fan 124b comprising substantially rounded design. As shown, its inlet 138a and an outlet 140a may comprise ends of convex shape. In the embodiment of FIG. 6b, one or more flow directors 144 may also comprise at least one rounded end, which may be of complimentary shape. For example, the outlet 130B of the inputting flow director 144 may comprise a concave shape. Similarly, the inlet 131A of the outputting flow director 144 may comprise a concave shape. Such a design allows the inlet 138a and outlet 140b of the fan 124b to align in a closer or tighter fit with the outlets/inlets 130A/131A of the directors 144.

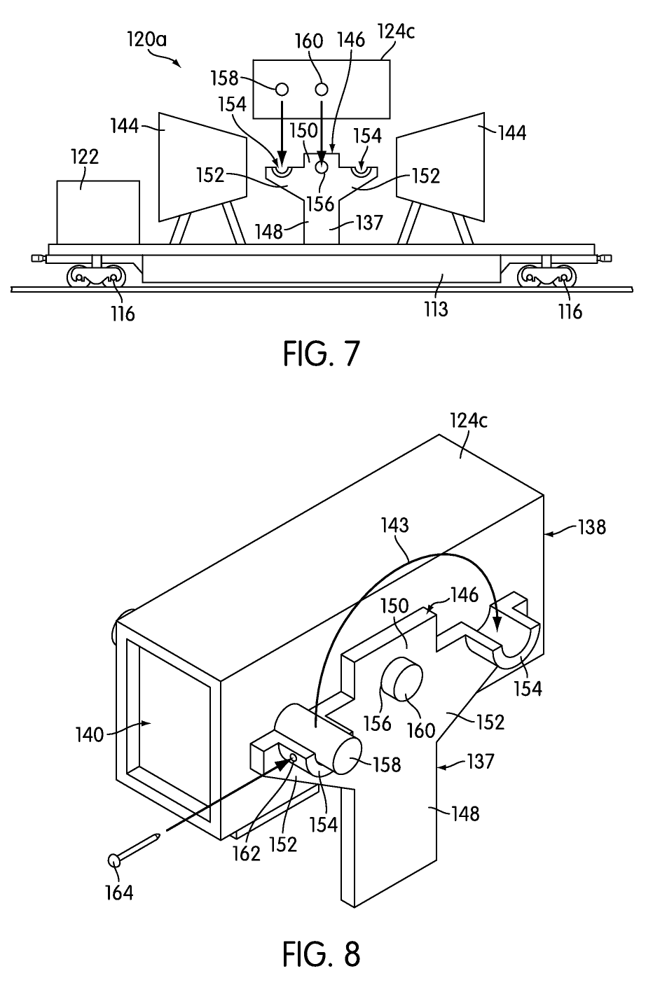

FIG. 7 illustrates an example embodiment of a mounting assembly 137 for mounting a fan 124c to the car body 113. The fan 124c may be a part of a fan car 120a as shown in FIG. 6a, for example. The mounting assembly 137 may comprise a base or bottom portion 148 that is attached to an upper or top portion of the car body 113. The bottom portion 148 may be attached to the car body 113 in any number of ways and should not be limiting. The bottom portion 148 as shown in FIG. 7 comprises an elongated structure which extends in a generally vertical direction from the top portion of the car body 113. In an embodiment, the bottom portion 148 comprises two similarly constructed portions for supporting the fan 124c. For example, as shown in FIG. 8, the bottom portion 148 may be duplicated on an opposite side of the fan 124c (not shown). Such a design allows for easy rotation of the fan 124c about the horizontal axis, for example. As such, it is to be understood that, although the elements of the mounting assembly 137 are described with reference to one side (the right side) as shown in FIGS. 7 and 8, a second side (left side) of similar but opposite construction is provided with the mounting assembly 137 to connect the fan 124c to the car body 113.

The mounting assembly 137 may also include a top connecting portion 150 and a number of side portions 152. The top connecting portion 150 has an upper portion 146 for assisting in mounting the fan 124c thereto. Specifically, the upper portion 146 includes a receiving opening 156 for receiving a mounting and pivoting pin 160 of the fan 124c. The mounting and pivoting pin 160 allows the fan 124c to rotate horizontally (as shown by arrow 143) about the horizontal axis. The side portions 152 extend outwardly in a substantially horizontal direction. The side portions 152 each comprise a stop, such as a seat or bushing 154, which are used to limit rotation of the fan 124c about the horizontal axis to 180 degrees. The fan 124c includes a stop pin 158 which are received in the stop bushing 154. Again, although only a first/right side is shown, it is to be understood by one in the art that stop pins 158 and stop bushings 154 are also provided on the second/left side as well. Additionally, in an embodiment, the pivot pin 160 may be an elongated bushing that extends from the first side to the second side through receiving openings 156. Alternatively, in another embodiment, the pivot pin 160 may comprise two separate pins.

FIG. 8 illustrates the method of using a locking pin 164 for locking the direction of the generated airflow by the fan 124c in FIG. 7 in accordance with an embodiment of the present invention. Specifically, the stop pin 158 is positioned in the left or rear stop bushing 154 of the side portion 152 so that the inlet 138 and outlet 140 are positioned to generate airflow in a longitudinal direction (such as shown in FIG. 1). In order to secure the fan 124c in this position, the stop bushing 154 is provided with at least one slot or hole 162 for receiving a locking pin 164 therethrough. The locking pin 164 may be placed through the hole 162 and bushing 154 to secure the fan 124c to the mounting assembly 137.

To switch the direction of the generated air, for example, the fan 124c may be pivoted about the horizontal axis using mounting and pivoting pin 160. As indicated the arrow 143, the stop pin 158 may be inserted and locked (e.g., using locking pin 164) in the right or front stop bushing 154. Of course, other devices (such as nuts and bolts, latches, etc.) may be used as securing devices. As such, FIGS. 7 and 8 illustrate an example of altering the direction of the generated airflow, and it is again noted that the methods or devices for locking the fan should not be limited to the illustrated embodiments.

As herein noted, placing a high-efficiency, high-velocity fan on a railroad car 113 which can be placed in a freight train 100 in proximity to the locomotive unit(s) 102 or 102a has not been previously considered. This fan car 120 and the above-noted features assist in imparting kinetic energy to the air in the tunnel annulus, thereby improving on the above-noted disadvantages including overheating and stalling of locomotives within the train 100.

It is noted that the location and grade (i.e., tilt) of the tunnel 114 is not significant to the features of this disclosure, and therefore should not be limiting to the depiction as illustrated in FIG. 1. For example, a tunnel 114 may be provided through mountain, valley, underwater, etc., and/or may also be provided at an upward angle, downward angle, or substantially horizontal angle.

Also, the devices and methods used to mount the described features, e.g., fan 124, flow directors 126 and 144, power source 122, mounting assemblies 137 and 139, locking devices 154 and 158, et al. should not be limiting.

For example, it is within the scope of the invention that the fan car 120 may be a car that is capable of mounting or stacking. That is, in an embodiment, a car 113 may comprise a surface or a container that is configured to be mounted on top of a bottom container such as a container 106 to form a stack (or double stack). In an embodiment, corner fittings or connection openings may be provided for securing the car 113/container to another container. Such a car 113 or container may be stacked on top of a bottom container that is located immediately behind a lead locomotive consist 102, located just ahead-of or behind a mid-train consist 102a, or located just ahead of a rear-end locomotive consist in a train. Providing a fan 124 or fan car 120 on top of another container would provide similar air flow stimulation benefits as noted above, for example.

In some cases, the supply of power to fan 124 may be periodically controlled. For example, it may be desirous to conserve energy of the power source 122 by limiting the supply of power to the fan 124 of the fan car 120 such that it generates airflow during a specific time period or in a specific location. In a possible embodiment, a communication device may be used to communicate with a control system or controller (not shown). The control system or controller may be provided to control a circuit, system, or processor of a system by interpreting and executing instructions that are fed thereto. For example, instructions may be provided to a controller for supplying, reducing, and/or stopping power fed to a power source. Such instructions may be provided wirelessly. In an embodiment, the power source 122 may include a control system and wireless communication device 170 in communication with each other for controlling the generation of airflow by the fan 124. For purposes of this invention, a “communication device” is to be defined as any type of instrument, device, machine, or equipment which is capable of transmitting, acquiring, decrypting, or receiving any type of electronic, data, audio, radio transmissions, signals, or other communication information, or any part of a circuit, module, software, or other component that is capable of facilitating the transmission and receipt of information relating to the fan car 120 and its elements. In an embodiment, the communication device 170 receives instructions based on a position of the fan car 120 along track 103. As will be described, the communication device 170 may receive instructions via radio frequency (RF) communication via an antenna or a global positioning system (GPS) via satellite, for example. Of course, the methods of receiving such communication for powering the fan 124 should not be limited to the disclosed embodiments.

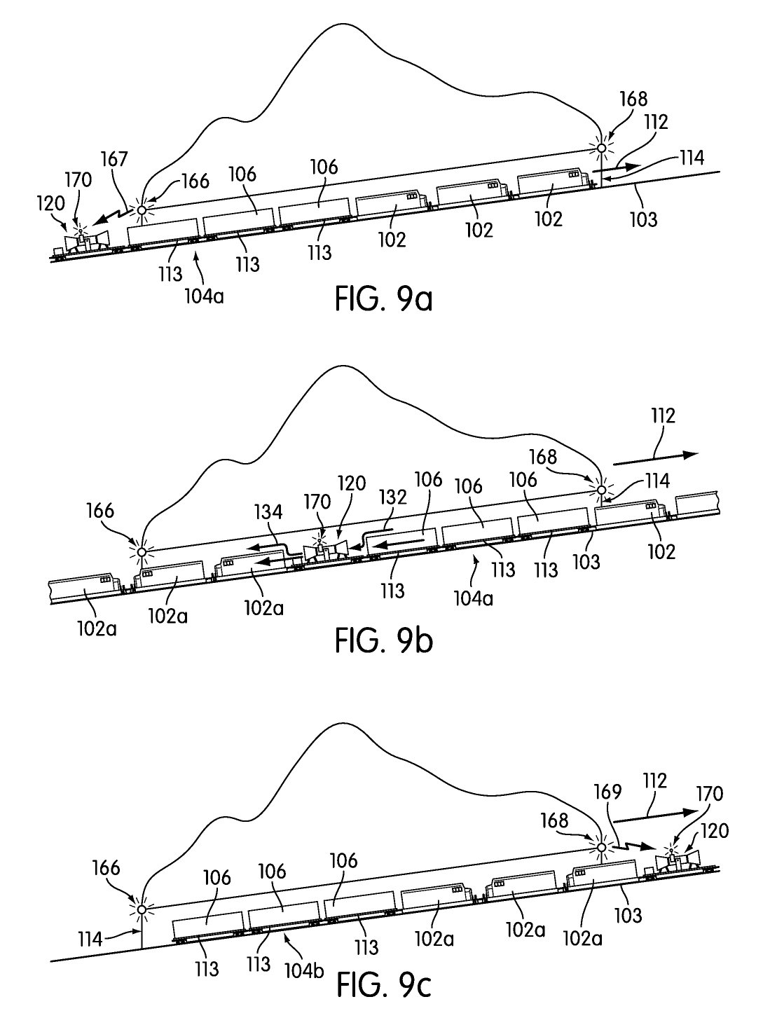

FIGS. 9a, 9b, and 9c illustrate an example of the train 100 of FIG. 1 using a wireless communication device 170 when travelling into, through, and out of (respectively) a tunnel 114 along a track 103 in accordance with an embodiment of the present invention. The communication device 170 provided on the fan car 120 is configured to receive instructions for supplying power to the power source 122. More specifically, the communication device 170 may be connected to a fan controller (not shown) on the car 120 for supplying power to the power source 122, and thus imparting motion to the fan (i.e., activating or deactivating rotation of the blades of the fan). For example, as shown in FIG. 9a, as the fan car 120 approaches an entrance of tunnel 114, the wireless communication device 170 receives instructions 167 from an entrance communication device 166 positioned near or adjacent the entrance. After the instructions 167 are received, power may be supplied by the power source 122 to the fan 124, and the fan car 120 is powered to generate airflow. As shown in FIG. 9b, as the fan car 120 travels through the tunnel 120, air is directed into the inlet of the fan 124 (and its flow directors 126, if provided) as represented by arrow 132 and discharged through outlet of the fan 124 as represented by arrows 134. As the fan car approaches and/or passes the exit of the tunnel 114, as shown in FIG. 9c, the communication device 170 may receive instructions 169 from an exit communication device 168 positioned near or adjacent the exit of the tunnel. The instructions 168 that are received may instruct the controller (or other device) to limit or stop the power supply from the power source 122 to the fan 124, thereby limiting the generation of airflow as it exits the tunnel.

In an embodiment, the wireless communication devices 166, 168, and/or 170 may utilize radio frequency communication. For example, the devices 166 and 168 may be short-range radio transmitters mounted with respect to a location of the tunnel 114 along the track 103. The communication device 170 of the fan car 120 may be a radio receiver.

Though FIGS. 9a and 9c illustrate a transmitter or communication device 166 mounted in a location with respect to the entrance or opening of the tunnel 114, and another communication device 168 mounted in a location with respect to the exit of the tunnel 114, the location of the communication devices 166, 168 for sending instructions to the device 170 of the fan car 120 should not be limiting. For example, the devices 166, 168 may be provided adjacent the track 103, within the tunnel 114, or a distance before the tunnel entrance and a distance after the tunnel exit.

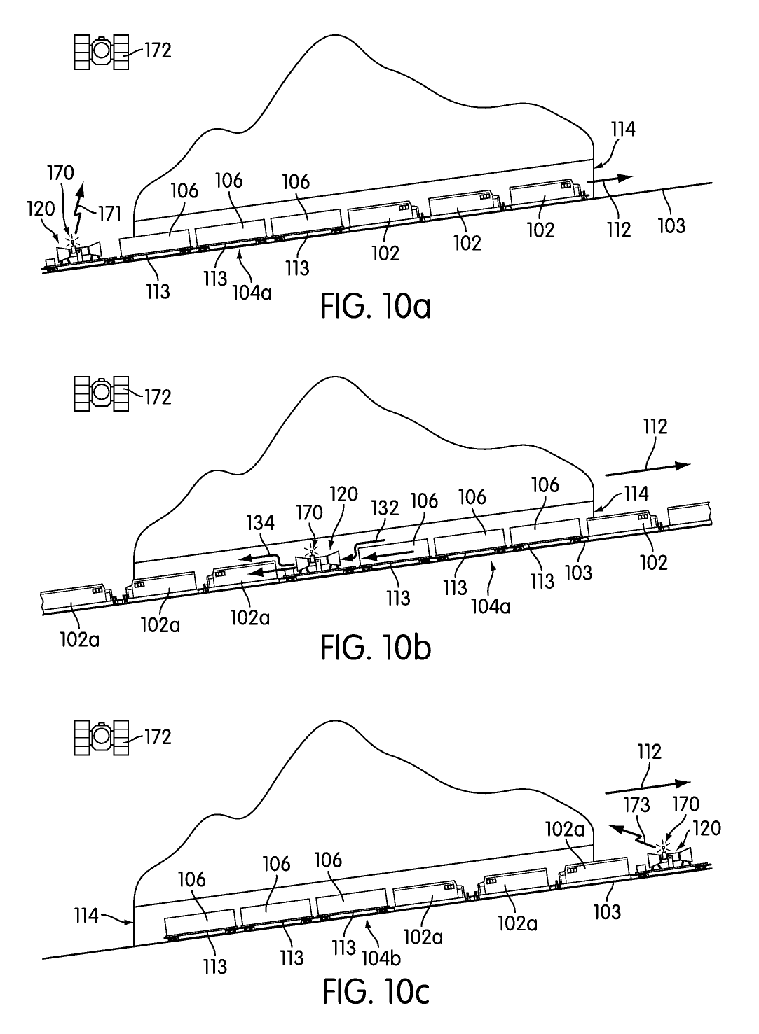

FIGS. 10a, 10b, and 10c illustrate an example of the train 100 of FIG. 1 using a communication device 170 when travelling into, through, and out of (respectively) a tunnel 144 along a track 103 in accordance with another embodiment of the present invention. In this embodiment, the fan car 120 is equipped with a communication device 170 having a global positioning satellite (GPS) receiver to determine its location. In some cases, for example, a fan controller of the fan car 120 may have known coordinates for one or more tunnel locations provided along a track 103 programmed therein. This may allow the controller/power source 122 to supply power to the fan 124 according to such coordinates, thereby activating or deactivating rotation of the blades of the fan to generate airflow as it enters and exits the tunnel 114, for example.

In another possible embodiment, the controller may be designed to alert itself that power should be supplied to the power source 122 of the fan car 120 when a signal is no longer detected. For example, as shown in FIG. 10a, the communication device 170 is in communication with satellite 172, as represented by arrow 171, to send its location coordinates, for example. Upon reaching or entering a tunnel 114, as shown in FIG. 10b, the controller may determine that the GPS signal has disappeared/cannot be located (i.e., that the communication device 170 can no longer send or receive information to the satellite 172 because it is inside the tunnel). The controller may be designed such that the determination of a lack of communication or signal indicates that the power source of the fan should be activated/supply turned on, thereby allowing for the generation of airflow (as represented by arrows 132 and 134) of the fan 124. Additionally and/or alternatively, upon exiting the tunnel 114, the communication device 170 may re-establish communication with the satellite system 172 as represented by arrow 173 and a signal may be detected by the controller. As such, when the signal reappears, the controller may limit or stop the supply of power to the power source 122, thereby deactivating or turning off the fan 124.

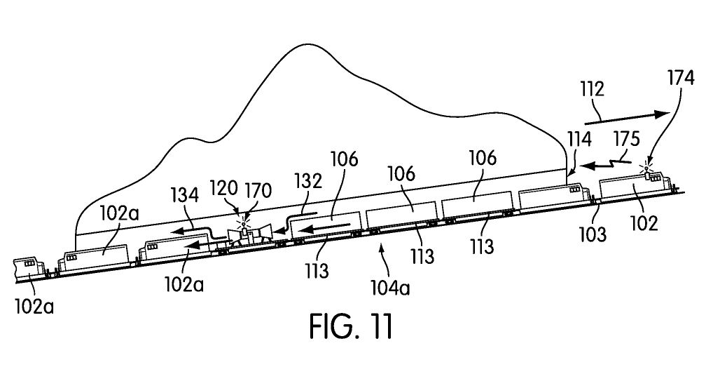

In another possible embodiment, FIG. 11 illustrates an example of using a communication device 170 of the fan car 120 in communication with a local communication device 174 provided in or on the train 100. For example, the lead locomotive 102 (or consist) may comprise a local communication device 174 for supplying instructions as noted by arrow 175 to the wireless communication device 170 for controlling the power source 122. Power to the fan car 120 may be supplied in a similar manner as noted above (i.e., power supply is turned on to generate airflow when in the tunnel 114, turned off when out of the tunnel 114). Of course, the local communication device 174 may be provided in any number of locations along the train, including, but not limited to: on the leading locomotive(s) 102, following locomotive(s) 102a, in or on a car 113, on an operator, in a locomotive control board, etc. The device 174 may be automatically operated (e.g., using pre-programmed conditions) or manually operated (e.g., using an operator or engineer) to communicate instructions to wireless communication device 170. In some instances, the communication device 170 may be radio controlled from the locomotive 102. For example, voice radio may be used to communicate with device 170, thereby instructing controller to activate the fan 124 to generate airflow. In some instances, a “radio tone” created by a keypad or keyboard may be used to toggle on/off commands to the communication device 170 and controller. It is also envisioned that the local communication device 174 may implement a plurality of methods and devices. For example, voice radio may be used to send instructions to device 170, but a keypad for manual override (so as to stop the rotation of fan 124 in emergencies, for example) may be provided as well. Use of such a local communication device 174 allows for customized activation or deactivation of the fan 124 on fan car 120.

The methods and/or devices used to control or communicate with the fan car 120 and its components should not be limited to the described embodiments. For example, in an embodiment, it is also envisioned that a wayside system may be used to communicate with the communication device 170 for powering the fan 124 of the fan car 120. The wayside system may be provided adjacent a tunnel entrance/exit or any other desirable place along a track for the generation of airflow. Of course, the devices used as for communicating such instruction should not be limiting as well.

While the principles of the invention have been made clear in the illustrative embodiments set forth above, it will be apparent to those skilled in the art that various modifications may be made to the structure, arrangement, proportion, elements, materials, and components used in the practice of the invention.

It will thus be seen that the objects of this invention have been fully and effectively accomplished. It will be realized, however, that the foregoing preferred specific embodiments have been shown and described for the purpose of illustrating the functional and structural principles of this invention and are subject to change without departure from such principles. Therefore, this invention includes all modifications encompassed within the spirit and scope of the following claims.

What is claimed is:

1. A car for use in a train, the car comprising:
a car body and track engaging wheels;
the car body including couplings for coupling the car within the train;
a fan connected to the car body, the fan having an inlet for receiving air and an outlet for discharging air and the fan being constructed to generate airflow at least in part in a longitudinal direction of the train when the car body is coupled to the train.

2. The car according to claim 1, further comprising one or more flow directors for directing the airflow generated by the fan.

3. The car according to claim 2, wherein the one or more flow directors comprises a pair of Y-shaped flow directors positioned on opposing longitudinal sides of the fan, each with a single part facing the fan and a pair of diverging parts facing away from the fan.

4. The car according to claim 1, further comprising a power source for imparting motion to the fan to generate the airflow, and wherein the power source is chosen from a group including: a battery, a generator, a motor, and an engine.

5. The car according to claim 4, wherein the power source is rechargeable.

6. The car according to claim 4, wherein the power source is mounted to the car body.

7. The car according to claim 4, further comprising a wireless communication device configured to receive instructions for supplying power to the power source.

8. The car according to claim 7, wherein the wireless communication device receives instructions based on a position of the car along a track.

9. The car according to claim 7, wherein the wireless communication device receives instructions via radio frequency communication or GPS.

10. The car according to claim 1, wherein the fan is connected to the car body via a pivoting connection, the pivoting connection allowing for adjustment of the fan with respect to the car body between at least two positions so that the direction of the generated airflow with respect to the train is adjustable.

11. The car according to claim 10, wherein the pivoting connection rotates about a vertical axis of the car body.

12. The car according to claim 11, wherein the fan is capable of pivoting up to and including 360 degrees about the vertical axis.

13. The car according to claim 10, wherein the pivoting connection rotates about a horizontal axis that is perpendicular to the longitudinal direction of the train.

14. The car according to claim 13, wherein the fan is capable of pivoting up to and including 180 degrees about the horizontal axis.

15. A train comprising:
at least one locomotive, the at least one locomotive comprising a body, track engaging wheels, and a power system for driving the track engaging wheels to move the locomotive and train along tracks;
a series of cars each comprising a car body, track engaging wheels, and couplings for coupling the car within the train;
one or more of the cars configured to transport cargo; and
one or more of the cars comprising a fan connected to the car body, the fan having an inlet for receiving air and an outlet for discharging air and the fan being constructed to generate airflow at least in part in a longitudinal direction of the train when the car body is coupled to the train.

16. The train according to claim 15, wherein the one or more cars comprising the fan is mounted adjacent to a locomotive.

17. The train according to claim 15, wherein the one or more cars comprising the fan is mounted in front of a locomotive within the train.

18. The train according to claim 15, wherein the one or more cars comprising the fan is mounted in behind a locomotive within the train.

19. The train of claim 15, wherein:
the at least one locomotive comprises a leading locomotive and a following locomotive, the leading locomotive configured to lead the series of cars along the tracks, and the following locomotive being located rearward of the leading locomotive and configured to assist in moving the series of cars along the tracks.

20. The train according to claim 19, wherein the one or more cars comprising the fan is mounted forward of the following locomotive in the train.

21. The train according to claim 20, wherein the leading locomotive and the following locomotive each comprise two or more locomotives connected in series.

22. The train according to claim 15, wherein the fan is connected to a power source for imparting motion thereto to generate the airflow, and wherein the power source is chosen from a group including: a battery, a generator, a motor, and an engine.

23. The train according to claim 22, wherein the power source is rechargeable.

24. The train according to claim 22, wherein the power source is mounted to the car body that the fan is connected to.

25. The train according to claim 22, further comprising a wireless communication device configured to receive instructions for supplying power to the power source.

26. The train according to claim 25, wherein the wireless communication device receives instructions based on a position of the car along a track.

27. The train according to claim 25, wherein the wireless communication device receives instructions via radio frequency communication or GPS.

28. The train according to claim 15, further comprising one or more flow directors for directing the airflow generated by the fan.

29. The train according to claim 15, wherein the fan is mounted to the car body via a pivoting connection, the pivoting connection allowing for adjustment of the fan with respect to its car body between at least two positions so that the direction of the generated airflow with respect to the train is adjustable.

30. The train according to claim 15, wherein the pivoting connection rotates about a vertical axis of its car body.

31. The train according to claim 15, wherein the pivoting connection rotates about a horizontal axis that is perpendicular to the longitudinal direction of the train.

32. A method of using a train to increase air movement, the train comprising at least one locomotive having a body and track engaging wheels; a series of cars each comprising a car body, track engaging wheels, and couplings for coupling the car within the train; one or more of the cars configured to transport cargo; and one or more of the cars comprising a fan connected to the car body, the fan having an inlet for receiving air and an outlet for discharging air, the method comprising:
moving the train along a track, and
generating airflow at least in part in a longitudinal direction of the train using the fan.

33. The method according to claim 32, wherein the train further comprises a power source for imparting motion to the fan to generate the airflow and a wireless communication device configured to receive instructions for supplying power to the power source, the method further comprising:
receiving instructions from a remote system to supply power to the power source; and
powering the power source,
thereby imparting motion to the fan to generate the airflow.

34. The method according to claim 33, wherein the remote system is mounted in a position along a track that is adjacent a tunnel.

35. The method according to claim 33, wherein the remote system is a GPS.

36. The method according to claim 33, wherein the remote system is provided in the at least one locomotive.
